(19) United States
(12) Patent Application Publication
(10) Pub. No.: US 2007/0299368 A1
(43) Pub. Date: Dec. 27, 2007

(54) Back spasm reliever

(76) Inventor: Richard McCarthy, Bainsville (CA)

Correspondence Address: JACK PAAVILA, BOX 1151, ALEXANDRIA, KOC IA0, omitted

(21) Appl. No.: 11/809,835

(22) Filed: May 31, 2007

Related U.S. Application Data
(60) Provisional application No. 60/809,354, filed on May 31, 2006.

(51) Int. Cl. A61H 1/00; A61H 1/02

(52) U.S. Cl. 601/1

(57) ABSTRACT

A back spasm relieving device has a narrow torso encircling belt, the belt having cooperating, adjustable, fastening means to fasten the belt about a torso. The device includes a pair of conical shaped pressure applying members each having a base and a rounded end. There are receiving means on the inner surface of the belt about midway along the length of the belt for receiving the pressure applying members with their bases adjacent the inner surface of the belt. The pressure applying members are held side-by-side on the belt by the receiving means. A person, with back spasms, wraps the belt about his torso and secures it tightly with the tips of the cones located on either side of the spine and pressing into the person's body in the vicinity of the spasms. The person can lay down on the floor to have his weight press the members into his body to relieve the spasms.

### BACKGROUND OF THE INVENTION

1. Technical Field

This invention is directed toward a back spasm reliever.

2. Background Art

Back spasms are characterized by tight and tender muscles immediately adjacent to one or both sides of the spine. The back spasms can be relieved with the application of deep massage pressure applied by the hands of another person. It is difficult however for a person to find relief on his own.

### SUMMARY OF THE INVENTION

It is the purpose of the present invention to provide a device which a person can use himself to relieve back spasms. The device can be mounted on the person and carries pressure applying members that can be located over the back spasm area of the person's back. The person then lays on the floor on his back to have the pressure applying members deeply penetrate the person's back in the area of the back spasms to relax the muscles and relieve the spasms.

The device has a flexible belt large enough to encircle a person's torso, the belt carrying two conical members that can be positioned on either side of the spine in the area where the back spasms are occurring. Once the conical members are positioned to press into the area of the back where the back spasms occur, the wearer of the belt can lie down to have the tips of the conical members press deeply into the back to relax the muscles to relieve the spasms.

The invention is particularly directed toward a back spasm reliever having a narrow, torso encircling belt and a pair of conical-shaped, pressure applying members each having a base and a rounded end. Receiving means on the belt receive the conical members on the belt with their base adjacent the belt. The belt is adapted to be mounted about the torso of a user with the rounded ends of the conical members pressing against back muscles on each side of the spine in the area of back spasms.

### DESCRIPTION OF THE SEVERAL VIEWS OF THE DRAWINGS

FIG. 1 is a front view of the device with the belt stretched out and with the conical members shown above the receiving means on the belt which receiving means receive the members;

FIG. 2 is a cross-section view of a conical member mounted on the belt;

FIG. 3 is a schematic view of the belt being worn;

FIG. 4 is a detail front view showing another receiving means for the conical members on the belt;

FIG. 5 is a cross-section view taken along line 5-5 in FIG. 4 with a conical member in the pocket; and

FIG. 6 is a detail front view of a modified belt, partly broken away, with two sets of pockets.

### DETAILED DESCRIPTION OF THE INVENTION

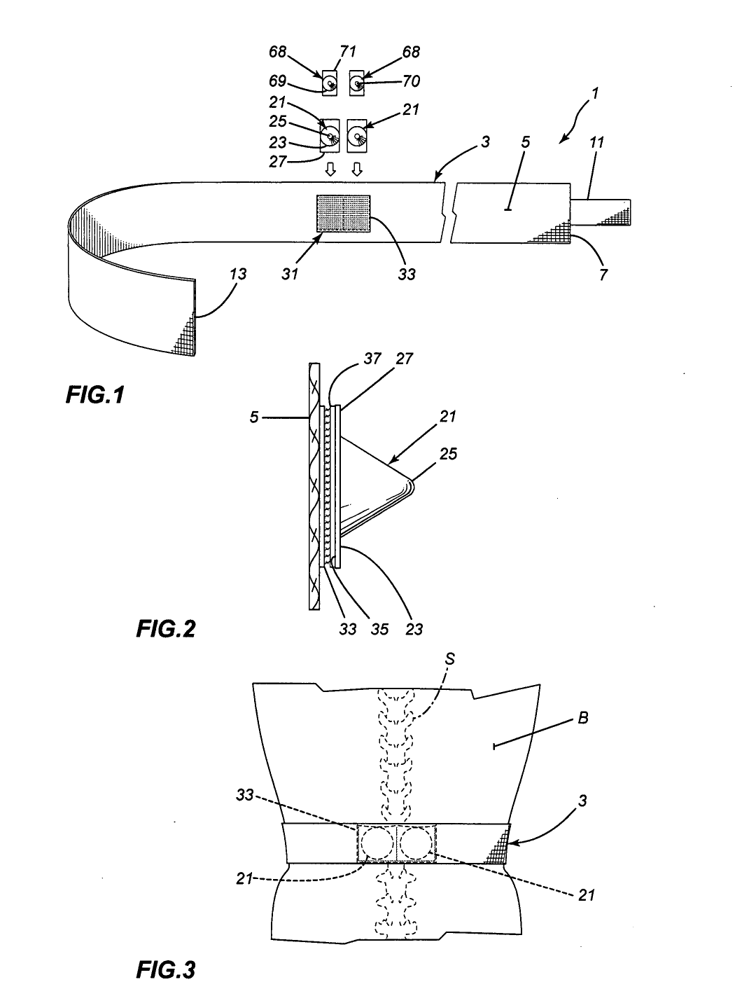

The back spasm reliever 1 has a belt 3, as shown in FIGS. 1 and 2, which comprises a cloth band about four inches wide and long enough to encircle a person's torso. The inner surface 5 of the belt 3, which will lie against the person, can be cushioned. The belt 3 has cooperating connecting means for detachably connecting one end 7 of the belt to itself. The connecting means can include an outer surface 9 on the belt made of fabric material similar to that forming one of the two fabric materials used in hook and eye fasteners such as Velcro® fasteners. The connecting means includes a flap 11 which extends from the end 7 of the belt and which is fastened on its inner surface 5. The flap 11 is made of the other fabric material forming the hook and eye fastener. The hooks or eyes on the flap are on its inner surface so they will overlie the outer surface 9 of the belt when the end 7 of the belt overlaps its other end 13 to connect the belt to itself. Other types of known connecting means used to connect one end of a belt to itself can be used.

The device includes at least two identical pressure applying members 21. The members 21 are conical members, each having a flat base 23 with a rounded top 25. Each member 21 has a height about equal to the diameter of the base 23. Preferably, the members are about two and one quarter inches tall and have a base about two and one quarter inches in diameter. The height and diameter of the members has been chosen as being the best suited to apply deep pressure to the larger muscles in the back. The members are rigid and molded from suitable plastic material. They can be solid or hollow. Each conical member 21 preferably has a rectangular support plate 27 attached to the base 23, the plate having a length of about three inches and a width of about two and one quarter inches. The plate 27 adds stability to the member 21 when the member rests on its base.

The belt has receiving means 31 for receiving the conical members 21. The receiving means 31 can comprise a rectangular, fabric belt patch 33 of one of the two Velcro® type materials used to form hook and eye fasteners. The patch 33 is sewn onto the inner surface 5 of the belt at about its center. The bottom 35 of the support plate 27 on the conical members 21 is also covered with a member patch 37 of the other of the two Velcro® type materials. The support plate 27 provides a larger surface area of Velcro® type material than the base 23 of the conical member 21 would provide making for a more secure fastening of the member 21 to the belt patch 33. Each conical member 21 is fastened to one half the belt patch 33 so that the pair of members are side-by-side. While it is preferred to use the support plate 27 on the conical members 21, the members 21 could be used without the support plate. In this case, the member patch 37 can be circular, the size of the base 23, and attached directly onto the base 23 of the conical member 21.

A person wishing to relieve back spasms places the conical members 21 onto the belt patch 33, the member patches 37 on the members 21 adhering to the belt patch 33. He then wraps the belt 3 about his torso at the height where the conical members 21 will press against his back B at the area of the back spasms as shown in FIG. 3. The members 21 are positioned on either side of the spine S. The belt is tightened and the flap 11 is then attached to the belt to keep the belt in place. The person then lies on the floor on his back, or presses his back against a wall, to have the rounded tops 25 of the members 21 press deeply into his back to relax the muscles to relieve the spasms.

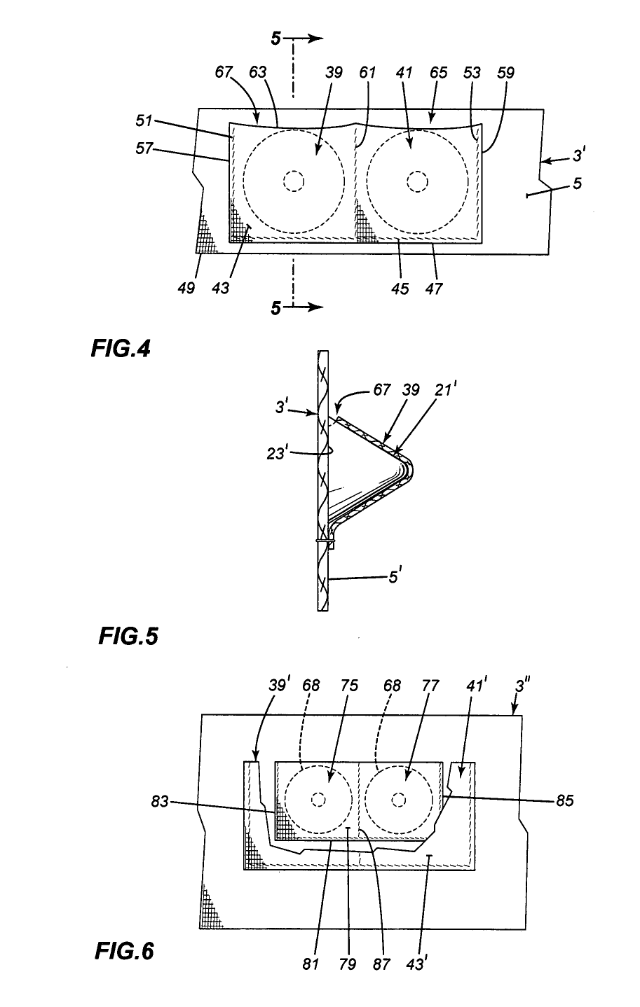

One form of receiving means on the belt for receiving the conical members 21 has been described. Other receiving means can be employed. For example the receiving means can comprise a pair of adjacent pockets 39, 41 attached to the inner surface 5′ of the belt 3′ at about its center as shown in FIG. 4. The pockets 39, 41 replace the belt patch 33. The pockets can be formed by stitching a rectangular, elastic, panel 43 onto the inner surface 5′ of the belt 3′, the panel and belt together forming the pockets 39, 41. A bottom line 45 of stitching joins the bottom edge 47 of the panel 43 to the bottom edge 49 of the belt 3′ and two side lines 51, 53 of stitching join the side edges 57, 59 of the panel 43 to the belt. A central line 61 of stitching parallel to the two side lines 51, 53 of stitching divides the panel 43 into the two pockets 39, 41. Each pocket 39, 41 is open at the top edge 63 of the panel 43 providing openings 65, 67 to the pockets. The elastic panel 43 is stitched to the belt 3 in a relaxed condition.

The conical members 21′ used with a belt having pockets 39, 41 do not need Velcro®-type material on their base or on the support plate, if used. The conical members 21′ are placed in the pockets 39, 41 through the openings 65, 67 with their base 23′ or with the support plates 27′, if used, adjacent the belt 3′ as shown in FIG. 5. The panel portion forming each pocket 39, 41 stretches to accommodate the members 21′ and to hold them in place in the pockets. Once the members 21′ are placed in the pockets 39, 41, the belt 3 is wrapped about the torso of the user as before with the members 21 generally located one on either side of the spine S. The belt is located on the back at about the approximate height of the spasms.

A second pair of pressure applying members 68 could be provided for the device 1 which members are also conical but slightly smaller than the first pair of conical members 21. The second pair of smaller conical members 68 could be about one and one-quarter inches high with a base 69 diameter of about one and three-quarters inches. The first pair of conical members 21 would be used on the larger, lower, back muscles in the vicinity of the lower or lumbar vertebrae L5 to T10 of the spine. The rounded ends 25 of the conical members 21, when mounted on the belt 3, would be spaced slightly more than two and one half inches apart. The smaller pair of conical members 68 could be used on the smaller, higher, back muscles in the vicinity of the upper or dorsal vertebrae T9 to T1. The rounded ends 70 of the smaller members 68, when mounted on the belt 3, would be about two inches apart. The smaller pair of members 68 could be provided with rectangular support plates 71. A cone patch of velcro material is applied either on the base 69 of the member 68, if used without the support plate 71, or on the support plate 71 if used, when the cones are used with a belt having a velcro belt patch.

If the second pair of conical members 68 are used with a belt with pockets, the cones do not need cone patches. The members 68 are held securely enough within the pockets 39, 41 by the elastic panel 43, positioned closely adjacent the central line 61 of stitching. They would be placed in the pockets to have their rounded ends 70 about two inches apart.

If desired, a secondary pair of pockets 75, 77 could be formed between the belt 3″ and the first pair of pockets 39′, 41′ to receive the second smaller pair of conical members 68 as shown in FIG. 6. The secondary pair of pockets 75, 77 could be formed by a second, smaller, rectangular, elastic panel 79 fastened to the belt 3″. The panel 79 is fastened to the belt 3″ before the panel 43′ is fastened thereto. The panel 79 is fastened to the belt 3″ with a bottom line of stitching 81 and two side lines 83, 85 of stitching. A central line 87 of stitching parallel to the side lines 83, 85 of stitching form the secondary pockets 75, 77 in the second panel 79. The pockets 75, 77 can be formed to be slightly spaced apart by using two lines of central stitching about one half inch apart instead of using a single central stitching line 87. Spacing the pockets 75, 77 slightly apart locates the rounded tips of the smaller conical members 68 about two inches apart.

The outer main panel 43′ would overlie the secondary panel 75. The inner pockets 75, 77 formed by the secondary panel 79 would be too small to receive the large conical members 21.

I claim:

1. A back spasm relieving device having a narrow torso encircling belt, the belt having cooperating, adjustable, fastening means to fasten the belt about a torso, a pair of conical shaped pressure applying members each having a base and a rounded end, and receiving means on the inner surface of the belt about midway along the length of the belt for receiving the pressure applying members with their bases adjacent the inner surface, the members held side-by-side on the belt by the receiving means.

2. A back spasm relieving device as claimed in claim 1 wherein the receiving means comprises a patch of one velcro-like material on the inner surface of the belt, the bases of the conical members also covered in patches of a second velcro-like material which cooperates with the one velcro-like material on the belt to hold the conical members by their bases to the belt.

3. A back spasm relieving device as claimed in claim 1 wherein the conical members have a rectangular plate on the base to provide stability to the members.

4. A back spasm relieving device as claimed in claim 3 wherein the receiving means comprises a patch of one velcro-like material on the inner surface of the belt, the plates of the conical members also covered in patches of a second velcro-like material which cooperates with the one velcro-like material on the belt to hold the conical members by their plates to the belt.

5. A back spasm relieving device as claimed in claim 1 wherein the receiving means comprises a first pair of adjacent pockets formed on the inner surface of the belt in about the center of the belt in the lengthwise direction of the belt, each pocket sized to snugly hold one of the conical members with its base adjacent the belt.

6. A back spasm relieving device as claimed in claim 5 wherein the pockets are formed by stitching an elastic panel to the inner surface of the belt.

7. A back spasm relieving device as claimed in claim 5 having a second pair of smaller conical shaped pressure applying members adapted to be mounted in the pockets in place of the first pair of conical members when needed.

8. A back spasm relieving device as claimed in claim 5 including a second pair of smaller adjacent pockets formed on the inner surface of the belt within the first pair of pockets, the device having a second pair of smaller conical shaped pressure applying members adapted to be mounted in the second pair of pockets in place of the first pair of conical members when needed.

9. A back spasm relieving device as claimed in claim 8 wherein the second pair of pockets are formed by stitching a second elastic panel to the inner surface of the belt, the second panel being smaller than the first panel and located between the first panel and the inner surface.
